(19) United States
(12) Patent Application Publication
(10) Pub. No.: US 2023/0422020 A1
(43) Pub. Date: Dec. 28, 2023

(54) METHODS AND DEVICES FOR ACTIVATING AND/OR DEACTIVATING A RADIO

(71) Applicant: SAGEMCOM BROADBAND SAS, Rueil Malmaison (FR)

(72) Inventor: Massinissa LALAM, Rueil Malmaison (FR)

(21) Appl. No.: 18/340,652

(22) Filed: Jun. 23, 2023

(30) Foreign Application Priority Data
Jun. 23, 2022 (FR) 2206242

(51) Int. Cl. H04W 8/22

(52) U.S. Cl. CPC H04W 8/22

(57) ABSTRACT

A communication device is described comprising at least one first radio configured to be active when the device is in operation; at least one second radio configured to be selectively active or deactivated when the device is in operation; a processor and a memory containing code which when executed by the processor causes the device to:
detect the association of a client device with an access point of an active radio from the at least one first radio and at least one second radio;
determine whether the client device supports a second deactivated radio from the at least one second radio and if so, activate said second deactivated radio.

Additionally, a method associated with the device and a device and a method for deactivating a second radio are described.

### CROSS-REFERENCE TO RELATED APPLICATIONS

The present application claims priority to French Application No. 2206242 filed with the Intellectual Property Office of France on Jun. 23, 2022 and which is incorporated herein by reference in its entirety for all purposes.

### TECHNICAL FIELD

Methods respectively for activating and/or deactivating a radio of a multi-radio device are described. Devices implementing said methods are also described. The invention can be used in the context of communication networks, in particular but not only local communication networks.

### TECHNICAL BACKGROUND

It is desirable to reduce the consumption of a radio comprising a wireless network access point, for example a local network of the “Wi-Fi” (registered trademark) type, and in particular when the access point is not solicited by a terminal. For example, it is possible to reactivate a deactivated radio periodically to detect any association requests. However, such an approach is not satisfactory because it best introduces a delay in the association of a terminal.

### SUMMARY

One or more embodiments relate to a device comprising
at least one first radio configured to be active when the device is in operation;
at least one second radio configured to be selectively active or deactivated when the device is in operation;
a processor and memory containing code which when executed by the processor causes the device to:
   detect the association of a client device with an access point of an active radio from the at least one first radio and at least one second radio;
   determine whether the client device supports a second deactivated radio from the at least one second radio and if so, activate said deactivated second radio.

According to one or more embodiments, the processor executing the code causes the device to announce the activation of a second radio over at least one radio already active from the at least one first radio and at least one second radio.

According to one or more embodiments, said support is determined by a client device of one or more second radios on the basis of an item of information contained in the association request.

According to one or more embodiments, the processor executing the code prompts the device to transmit, to the client device, a request for transition to an access point of said second radio once the latter has been activated.

One or more embodiments relate to a method implemented by a communication device comprising
at least one first radio configured to be active when the device is in operation;
at least one second radio (configured to be selectively active or deactivated when the device is in operation;
a processor and memory containing code that when executed by the processor causes the communication device to implement the method, said method comprising:
   detect the association of a client device with an access point of an active radio from the at least one first radio and at least one second radio;
   determine whether the client device supports a second deactivated radio from the at least one second radio and if so, activate said deactivated second radio.

According to one or more embodiments, the method comprises announcing the activation of a second radio over at least one already active radio.

According to one or more embodiments, said support is determined by a client device of one or more second radios on the basis of an item of information contained in a frame received from the client device.

According to certain embodiments, the frame is an association frame or a measurement request frame.

According to one or more embodiments, the method comprises transmitting to the client device a request to transition to an access point of said second radio once activated.

One or more embodiments relate to a communication device comprising
at least one first radio configured to be active when the device is in operation;
at least one second radio configured to be selectively active or is deactivated when the device is in operation;
a processor and memory containing code which when executed by the processor causes the device to:
   in response to a disassociation event of a client device associated with an access point of an active radio from the at least one first radio and at least one second radio, determine whether a second active radio is supported by at least one other client device associated with an access point of one of the active radios from the at least one first radio and at least one second radio, and
   if not, deactivate said second active radio.

According to one or more embodiments, said support is determined by a client device of one or more second radios on the basis of an item of information contained in a frame received from the client device.

According to certain embodiments, the frame is an association frame or a measurement request frame.

According to one or more embodiments, the determination is performed after a timeout following the disassociation event.

According to one or more embodiments, the deactivation of a radio comprises stopping of the electrical supply to one of:
all active components of the radio;
at least one power amplification circuit.

One or more embodiments relate to a method implemented by a communication device comprising
at least one first radio configured to be active when the device is in operation;
at least one second radio configured to be selectively active or deactivated when the device is in operation;
a processor and memory containing code that when executed by the processor causes the communication device to implement the method, said method comprising:
   in response to a disassociation event of a client device associated with an access point of an active radio, determining whether a second active radio is supported by at least one other client device associated with an access point of the one of the active radios, and
   if not, deactivating said second active radio.

According to one or more embodiments, said support is determined by a given client device of one or more second radios on the basis of an item of information contained in an association frame previously received from said given client device.

According to one or more embodiments, the determination is performed after a timeout following the disassociation event.

According to one or more embodiments, the deactivation of a second radio comprises stopping of the electrical supply to one of:
all active components of the radio;
at least one power amplification circuit.

One or more embodiments relate to a computer program product comprising instructions which, when the program is executed by a processor of a device, prompt said device to implement one of the described associated methods.

One or more embodiments relate to a storage medium readable by a device provided with a processor, said medium comprising instructions which, when the program is executed by a processor of a device, prompt one of the above devices to implement one of the described associated methods.

### BRIEF DESCRIPTION OF THE FIGURES

Further features and advantages will become apparent from the following detailed description, which may be understood with reference to the attached drawings in which:

FIG. 1 is a functional block diagram of a device according to a particular non-limiting embodiment;

FIG. 2 is a functional block diagram of a radio according to a particular non-limiting embodiment;

FIG. 3 is a flowchart of a method for activating and/or deactivating a secondary radio according to a particular non-limiting embodiment;

FIG. 4 is a sequence diagram of messages illustrating a method of transition from a client device to a radio according to a particular non-limiting embodiment;

FIG. 5 is a sequence diagram of messages according to a variant of the method according to FIG. 4;

FIG. 6 is a message sequence diagram illustrating a method for deactivating a secondary radio according to a particular non-limiting embodiment.

### DETAILED DESCRIPTION

In the following description, identical, similar or analogous elements will be referred to by the same reference numbers. Unless otherwise indicated, the diagrams are not necessarily to scale.

The block diagrams, flowcharts and message sequence diagrams in the figures illustrate the architecture, functionalities and operation of systems, devices, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller prompts the system or device to implement all or part of the functionalities of the blocks and/or steps of the processes or methods according to the exemplary embodiments. The software code can be stored in a memory or a readable medium accessible directly or via another module by the processor or controller.

A device according to one or more exemplary embodiments comprises at least two radios. A radio comprises the components for hosting at least one access point (“Access point”, or “AP”), which allows access to the network of the access point by client devices (also called terminals, or “stations”, or “STA”).

A device comprises at least one primary radio and at least one secondary radio. Primary radio means a radio which is in principle always activated when the device is in operation. Secondary radio means a radio which can be activated or deactivated.

The access points hosted by a radio operate on one and the same channel, which is the channel of the radio. Said channel belongs to a frequency band (for example: frequency bands around 2.4, 5 and 6 GHz respectively), the frequency band being subdivided into a plurality of channels over which a radio can operate.

A radio is referred to as activated if at least one access point hosted by said radio signals its presence. When the network is a network operated according to one of the standards of the Institute of Electrical and Electronics Engineers 802.11 family of standards, or is a “Wi-Fi” network, an access point indicates its presence, for example, by transmitting beacon frames or else may signal its presence by transmitting a response frame (“probe response”) to an information request frame (“probe request”) over the networks present received from a terminal. For an activated radio, the components necessary for the transmission and reception are powered.

A radio is said to be deactivated if no access point hosted by said radio signals the presence thereof or cannot signal its presence in response to a request. In this state, it is possible to cut the entire electrical power supply related to the use of said deactivated radio. According to an alternative embodiment, certain components may continue to be powered to facilitate restarting.

In the following, the example of a residential gateway operating a wireless network of the “Wi-Fi” type will be used by way of illustration. The device may be other than a gateway, it may for example be a router or a radio coverage repeater or a radio coverage extender in a meshed-type wireless network. The network may be other than a local network of the “Wi-Fi” type, including a cellular network operated for example according to one of the 2G/3G/4G/5G standards. A network is typically identified by a name. In the case of a “Wi-Fi” network, the name is the identifier “SSID”. The capabilities are determined by the standard with which the entities that operate within the wireless network are compatible. In one example, a client device, entity operating within the wireless network, implements functionalities according to the IEEE 802.11 standard described by the amendments b/g/n/ax for the 2.4 GHz band, implements functionalities according to the IEEE 802.11 standard described by the amendments a/n/ac/ax for the 5 GHz band and implements functionalities according to the IEEE 802.11 standard described by the amendments ax in the 6 GHz band. In this example, amendment ax determines the capabilities of the client device. In another example, an access point has functionalities enabling it to operate according to amendments among is those of the IEEE 802.11 standard and according to several bands from the 2.4 GHz, 5 GHz and 6 GHz bands. The capabilities of said access point are determined by said amendments and correspond to the functionalities of said access point. Stretching the terminology, it is possible to refer to standard IEEE 802.11 ax or IEEE 801.118ax technology instead of amendment 11ax for example. Encryption protocols, for example WPA2 or WPA3, may also be implemented in exchanges between network entities.

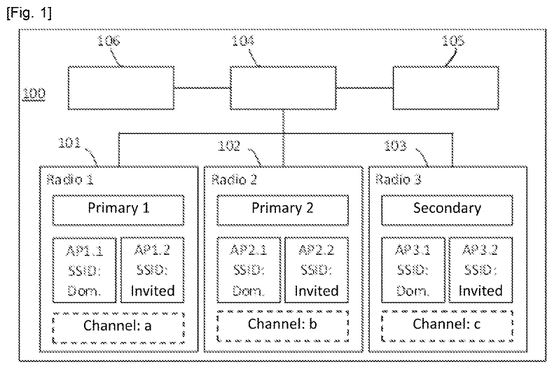

FIG. 1 is a block diagram according to one or more non-limiting exemplary embodiments. According to the example of FIG. 1, a gateway 100 comprises two primary radios 101, 102 and a secondary radio 103. In the example of FIG. 1, each radio comprises two access points, an access point to a private home network and another access point to a network for guests.

In the case where the gateway is a gateway of the “Wi-Fi” type, the home network and the network for guests of one and the same radio have distinct SSID identifiers.

The gateway 100 further comprises a processor 104, a long-term memory 105 and a working memory 106. The processor 104 controls the functionalities of the gateway and manages the various radios. The memory 105 includes software code that, when executed by the processor, prompts the device to implement one or more described methods. The memory 106 serves notably to store the data relating to the management of the radios, as well as data relating to the associated terminals or terminals likely to be associated with one of the access points. The respective channels on which the three radios work are the channels designated by “a”, “b” and “c”.

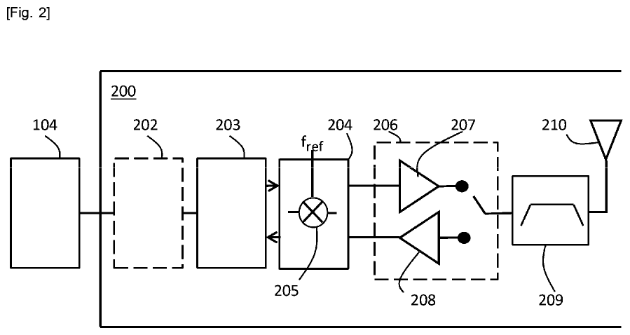

FIG. 2 is a diagram of the functional blocks of a radio 200 according to an exemplary embodiment provided by way of illustration. The radio 200 of FIG. 2 is an example of an implementation of one of the radios 101, 102 or 103 of FIG. 1. The radio 200 is controlled by means of the microcontroller or processor 104 of the host device, in the present case the gateway 100. The radio comprises a specific processor 202 and digital signal processing processor 203 commonly called “DSP”. The latter comprises a digital/analog converter on the transmission channel and an analog/digital converter on the reception channel. The clean processor 202 of the is radio is surrounded by a dotted line to indicate that it may be optional as a separate component depending on the implementation—indeed, according to some embodiments, its functionalities may be integrated with other components, such as the processor 104. The analog signals in transmission, respectively in reception, are modulated, respectively demodulated, by a radiofrequency modem 204. A front module 206 amplifies the transmission signal (power amplifier 207), while the reception signal is amplified by a low-noise converter block 208. A filter 209 switchable between the transmission channel and the reception channel is interposed between the output of the power amplifier 207 and the antenna 210 on the one hand and the input of the low-noise converter block 208 and the antenna 210 on the other hand. According to the present example, the filter 209 and the antenna 210 are passive components, while the other components are active components. It should be noted that in other implementations, the filter 209 and/or the antenna 210 may also be non-passive components.

FIG. 2 illustrates the case of a radio with a single transmission/reception chain, however a radio may comprise multiple transmission/reception chains. Some components may be common to multiple chains, for example the processor 202 or the digital signal processing processor 203.

According to certain embodiments, the deactivation of a radio amounts to deactivating the non-passive components of the radio, i.e. the power supply thereto is cut off. In the illustrative example of FIG. 2, the non-passive components comprise at least the signal processing processor 203, the modem 204, the front module 205, and if present and separately deactivatable, the own processor 202. If several reception/transmission chains are present, the non-passive components are deactivated for all chains. The non-passive components may be different in other implementations.

According to other exemplary embodiments, only a subset of said components is deactivated. For example, the power amplifier 207 being a high-consumption component, it is deactivated in priority. However, the processor 202, the digital signal processing processor 203 and the modem 204 are kept activated, i.e. powered, to allow a rapid restart of the radio. If the low-noise converter block 208 is kept activated and the switchable element 209 kept set to the reception chain, then the radio still has reception capabilities in order to detect, for example, information request frames.

Method for Activating and/or Deactivating a Secondary Radio

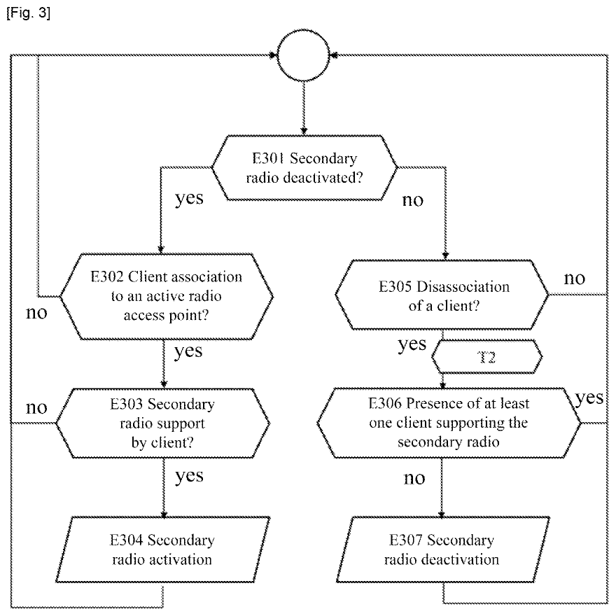

FIG. 3 is a flowchart of a method according to a non-limiting embodiment for the activation and/or deactivation of a secondary radio. In the following, the method will be described in its application to a secondary radio—it may however easily be extended to multiple secondary radios, as described as far as necessary later. In the case of a device with a single secondary radio, the method of FIG. 3 is for example implemented by the device 100 of FIG. 1.

The method comprises a method for activating a deactivated secondary radio and a method for deactivating an activated secondary radio. Although these two methods are presented in the same figure, they can be considered separately. In particular, it is possible to use an activation method such as that of FIG. 3, but to use a deactivation method other than the method illustrated by FIG. 3. Similarly, the deactivation method of FIG. 3 may be used with an activation method other than that of FIG. 3. According to the present embodiment, the method is implemented centrally under the control of the processor 104 of the gateway for all of the radios of the gateway. Depending on the state of a secondary radio, either the association events (client device joining a network operated by an access point of an activated radio), or the disassociation events (client device leaving a network operated by an access point of an activated radio) are considered. The activation method will monitor the association events (arrivals) of client devices on the activated access points and, if a client device supports the deactivated secondary radio, proceeds with the activation of said deactivated secondary radio. The deactivation method will monitor the disassociation events (departures) of client devices from the activated access points and the deactivation of an activated secondary radio if no other client device still associated with one of the access points of the device supports said secondary radio.

Method for Activating a Secondary Radio

In FIG. 3, an embodiment of the method for activating a secondary radio is illustrated by the left branch (301 to 304) of the flowchart.

Initially, in 301, it is determined whether a secondary radio is in the deactivated or non-deactivated state.

If the secondary radio is deactivated (positive test in 301), then the association events on all the access points hosted by activated radios are monitored to determine the association of a client device with one of the access points of the device implementing the method. In the event of association of a client device (positive test in 302), the secondary radios supported by said client device are determined and it is checked whether the deactivated secondary radio is part of the supported secondary radios (positive test in 303). If the deactivated secondary radio is part of the secondary supported radios, the deactivated secondary radio is activated (304). If the deactivated secondary radio is not one of the supported secondary radios (negative test in 303), the secondary radio remains deactivated, and the association events continue to be monitored.

According to one or more embodiments, the determination of the one or more radios supported by a client device is performed by analyzing association frames of the client device received via an access point of a primary radio or an active secondary radio.

In an example of a wireless network operating according to one of the 802.11 standards, an association procedure uses an association request frame and an association response frame. Disassociation uses a disassociation frame.

In the case of networks operating according to one of the 802.11 standards or networks of the “Wi-Fi” type, the information indicating the support of a radio by a client device can be determined from an information element (or “IE”) called the Supported Operating Classes. An analysis of the values contained in this information element makes it possible to determine which channels are supported by a client device and in which frequency bands. The information element is present in the association frame of a client device. The possible values are defined for example in Table E-4 of Annex E of the document IEEE802.11-2020 and the amendment thereof IEEE802.11 ax-2021.

By way of illustrative example, still in the case where the network is of the “Wi-Fi” type and if the secondary radio is a 6 GHz radio, then only the IEEE 802.11ax (or “Wi-Fi 6”) technology or a subsequent technology is supported by said secondary radio. Thus, if a client device is associated on a 5 GHz radio and indicates to the maximum the IEEE 802.11ac (or “Wi-Fi 5”) technology, it is not necessary to activate the 6 GHz radio, since the client device does not support the minimum technology required to operate in said band.

Depending on the type of network, a person skilled in the art will know how to adapt the information source to determine the radios supported.

The activation of a secondary radio comprises powering on of the components of said radio and the signaling of the presence of the access point(s) hosted by said secondary radio, for example according to one of the ways described previously.

According to a first alternative embodiment, once a secondary radio has been activated, the primary radio or radios announce that said secondary radio is activated. For example, the announcement may indicate the newly activated secondary radio operation channels.

According to a second variant embodiment, all the activated radios (whether primary or secondary) announce that said secondary radio is activated. In the case of several secondary radios, a secondary radio already activated then participates in the announcement of the activation of another secondary radio. For example, as above, the announcement may indicate the newly activated secondary radio operation channels.

Announcing the activation of a secondary radio on radios other than said secondary radio makes it possible to propagate this information effectively. This is particularly advantageous in the case where the band supported by the activated secondary radio is very wide (e.g. the 6 GHz band) in order to facilitate the discovery of the access points hosted by said secondary radio via associated client devices on access points hosted by radios other than said secondary radio.

In the case of a “Wi-Fi”-type network, the fact that an access point hosted by a secondary radio is activated is communicated by said access point by means is of the transmission of beacons and/or frames in response to a request. The fact that an access point hosted by a secondary radio is activated can also be communicated by means of the broadcasting of a compressed neighbor report information element (“Reduced Neighbor Report” or “RNR”) by the other access point(s), thus participating in the announcement. This information element can be broadcast via the beacon frames and/or the frames in response to a request.

If more than one secondary radio is present in the device, the activation method is implemented if at least one of said secondary radios is deactivated. The test in 301 is adapted accordingly. If more than one deactivated secondary radio is present in the device, it is verified for each one thereof (in 303) whether they are supported by a client device which has just associated (in 302) and each of the deactivated secondary radios supported by the client device is then activated (in 304).

The method is reiterated as long as at least one secondary radio is not active.

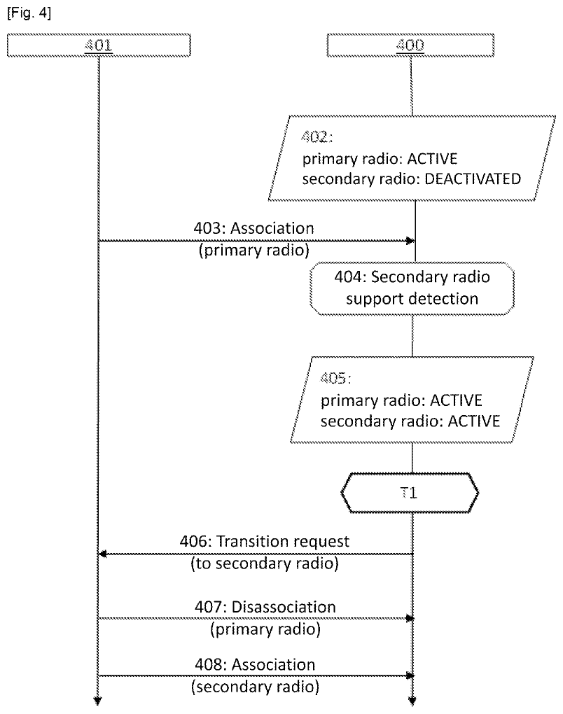

FIG. 4 is a diagram illustrating an embodiment of an optional method of transition of a client device 401 from a radio to which said device is associated to a secondary radio that has been activated. FIG. 4 shows inter alia the messages exchanged between the client device 401 and a device 400 comprising at least one primary radio and one secondary radio. The device 400 can for example be the device 100 of FIG. 1. In 402, a primary radio is active and a secondary radio is deactivated. In 403, the client device 401 is associated with an access point of the primary radio. The device 400 determines in 404 whether the client device 401 supports the deactivated secondary radio. It will be assumed in the context of the present example that this determination is positive. The secondary radio then becomes active (404). A time delay T1 is then triggered. After said time delay, the device 400 determines whether the client device 401 is still associated with an access point hosted by a radio other than the secondary radio that has been activated. The device 400 then transmits to the client device 401 a transition request 406 from the access point to which the client device is currently associated to an access point hosted by the secondary radio. The time delay T1 is optional, it may therefore be zero. According to certain embodiments, is the time delay T1 is of the order of a few milliseconds.

A transition may typically be initiated when it is necessary to distribute the load among the active radios.

According to one embodiment, the transition request comprises information allowing the client device to identify the secondary radio and/or one or more access points hosted by said secondary radio.

In the case of a “Wi-Fi”-type network, said transition request may in particular be issued by sending a “BSS Transition Management” or “BTM” frame. Said frame is defined in the IEEE 802.11v document and contains information allowing a client device to detect an access point hosted by the secondary radio and which would signal its presence. The frame is transmitted by the access point to which the client device is associated.

The client device receives the transition request 406. If the client device decides to respond positively to said request, it transmits a disassociation request 407 to the access point to which it is associated, then an association request 408 to an access point of the secondary radio. The transition is then completed.

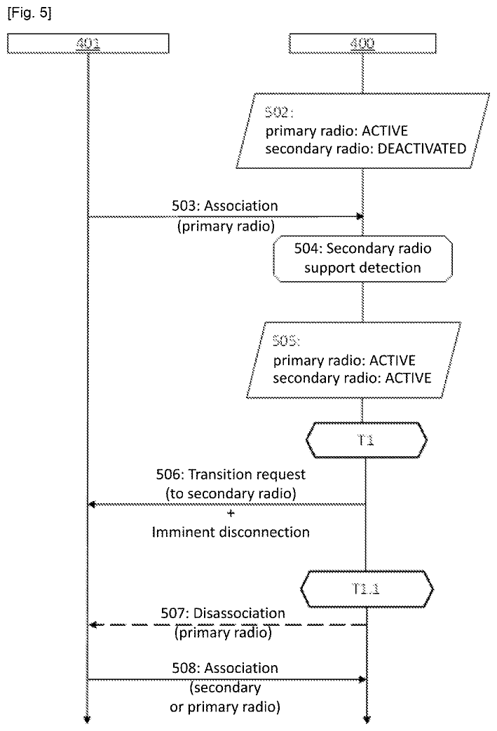

FIG. 5 is a diagram illustrating an alternative embodiment of the method of FIG. 4. In the context of this variant, the elements referenced 502 to 505 are respectively similar to the elements 402 to 405. A time delay T1 is also used. The transition request 506 of FIG. 5 also comprises, in addition to the data already described in connection with the transition request 406 of FIG. 4, an item of information for disconnecting from the client device 401 by the device 400 of the access point to which the client device is currently associated. The purpose of the transmission of this information by the device 400 is to prompt the client device 401 to perform the transition to the secondary radio. This disconnection information may for example indicate an imminent disconnection, after a time delay T1.1. In some implementations, the time delay T1.1 may be of zero value. In other implementations, it will for example be in the order of ten or one hundred milliseconds.

In the case of a “Wi-Fi”-type network, the imminent disconnection information may be included in the BSS Transition Management frame mentioned previously in relation to FIG. 4. The transmission of such a frame containing imminent disconnection information is in principle followed by the sending of a disassociation frame by the access point to which the client device 401 is associated to said client device. The client device may optionally request a time delay.

Following the transmission by the device 400 of the transition request 506 containing the imminent disconnection information and the optional time delay T1.1, a disassociation frame 507 is transmitted by the device 400. The client device 401 then transmits an association request 508 to an access point of a primary radio or an active secondary radio.

According to a variant of the transition method of FIG. 5, no disassociation frame 507 is sent by the device 400 to the client device, even though the sending of said frame is announced in the transition request frame 506.

In the case of a Wi-Fi network, according to a variant of one of the transition methods of FIGS. 4 and 5 (as well as the variant of the previous paragraph), the transition request is not issued using a BTM frame, but using an Agile Multiband frame defined by the “Wi-Fi Alliance” organization. The “Multiband” frame allows an access point to be more restrictive in its transition request.

It should be noted that FIGS. 4 and 5 show a simplified example where the device 400 comprises a primary radio and a secondary radio and where the client device 401 is initially associated with an access point of the primary radio. The device 400 may of course include more than one primary radio and/or more than one secondary radio and the method illustrated will be adjusted accordingly. For example, the client device 401 may initially be associated with an access point of any active radio, including secondary. The device 401 may also perform a transition to an access point of any active radio.

By virtue of the method for activating a secondary radio, the consumption of a device comprising at least one secondary radio is reduced by activating a secondary radio only when at least one client device supporting said radio is present.

According to certain embodiments, if the device comprises several secondary radios, then each one can be activated separately.

According to certain embodiments, the information of the radio or radios supported by a client device is obtained directly from the client device.

Method for Deactivating a Secondary Radio

Returning to FIG. 3, if the secondary radio is in the activated state (negative test in 301), then the client device disassociation events are monitored.

In the event of disassociation of a client device (positive test in 305), it is determined whether at least one other of the client devices still associated with the access points of the active radios supports the secondary radio. The disassociation event of a client device can be detected by receiving a disassociation frame sent by said client device or by sending a disassociation frame issued by the device 100 or by the absence of frames received from said client device despite the sending of requests issued by the device 100. This verification is performed after a time delay T2. According to certain exemplary embodiments, the time delay may have a duration of the order of one second.

If at least one associated client device supports the active secondary radio (positive test in 307), the latter is left in the activated state, if such is not the case (negative test in 307), then the secondary radio is deactivated (308). The time delay T2 makes it possible to ensure, before deactivating a secondary radio, that the client device supporting said secondary radio has actually exited the network, namely that it is associated with no access point signaling its presence and hosted by one of the active radios of the device 100.

If more than one secondary radio is present in the device, the deactivation method is implemented if at least one of said secondary radios is active. If more than one active secondary radio is present in the device, in the event of disassociation of a client device, it is verified for each said active secondary radio whether they are still supported by at least one of the client devices still associated with one of the radios of the device implementing the method. If appropriate, each of the active secondary radios which are no longer supported by any of the associated client devices are deactivated. The method is reiterated as long as at least one secondary radio is in the activated state.

According to a particular embodiment, the device maintains a list of client is devices associated with the access points of the active radios of the device, as well as for each client device, the list of the secondary radios supported. This task can for example be carried out under the control of a processor of the multi-radio device, for example the processor 104. It may also be distributed over the processors of each radio, whether they are separate components or integrated into other components.

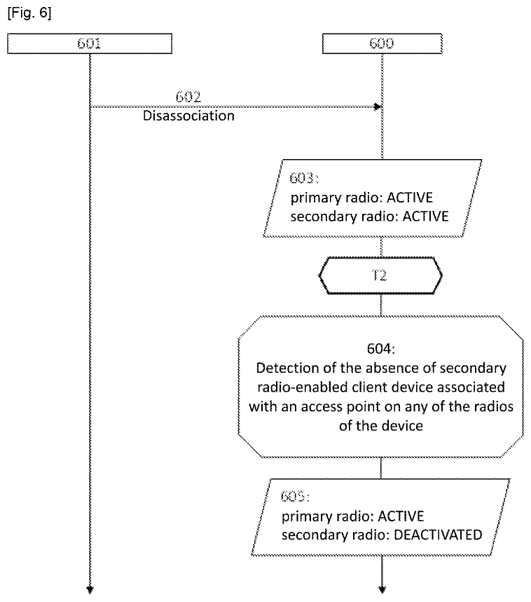

FIG. 6 is a sequence diagram of messages of the method for deactivating a secondary radio of a multi-radio device 600. A client device 601 is initially associated with an access point of an active secondary radio of the device 600. The client device 601 transmits a disassociation frame 602 to the device 600. In 603, a primary radio of the device 600 is active, while the secondary radio is also active. In 604, the device 600 checks whether at least one client device remains that is associated with an access point hosted by an active radio of said device 600 and which supports the secondary radio. Assuming that this is not the case, the device 600 modifies the secondary radio state—it is deactivated (605). If a client device supporting said secondary radio is still present, the state of the secondary radio is not modified and the device 600 waits for the next disassociation frame.

Although devices 400 and 600 above bear different reference numbers and are presented for separate methods in the figures, a same device can implement the two methods and their various embodiments and variants.

In the foregoing, various advantages have been described. A specific embodiment may have only one or more of said advantages, but not necessarily all the advantages. Certain embodiments may have one or more advantages that are not described and do not have any of the advantages described.

### REFERENCE SIGNS

100—Device
101—Primary radio 1
102—Primary radio 2
103—Secondary radio 3
104—Processor
105—Long-term memory
106—Working memory
200—Radio
201—Device processor
202—Radio processor
203—Digital signal processing processor
204—RF modulator/demodulator
205—Mixer
206—Front end module
207—Power amplifier
208—Low-noise converter block
209—Filter
210—Antenna
400—Multi-radio device
401—Client device
600—Multi-radio device
601—Client device

1. A communication device comprising
at least one first radio configured to be active when the device is in operation;
at least one second radio configured to be selectively active or deactivated when the device is in operation;
a processor and a memory having code that when executed by the processor causes the device to:
detect the association of a client device with an access point of an active radio from the at least one first radio and at least one second radio;
determine whether the client device supports a second deactivated radio from the at least one second radio and if so, activate said deactivated second radio.

2. The device of claim 1, wherein the processor executing the code causes the device to announce the activation of a second radio over at least one already active radio from the at least one first radio and at least one second radio.

3. The device according to claim 1, wherein the determination of the support by a client device of one or more second radios is performed on the basis of an item of information contained in a frame received from the client device.

4. The device according to claim 1, wherein the processor executing the code causes the device to transmit, to the client device, a request to transition to an access point of said second radio once it has been activated.

5. A method performed by a communication device comprising
at least one first radio configured to be active when the device is in operation;
at least one second radio configured to be selectively active or deactivated when the device is in operation;
a processor and memory containing code that when executed by the processor causes the communication device to perform the method, the method comprising:
detecting the association of a client device with an access point hosted by an active radio from the at least one first radio and at least one second radio;
determine whether the client device supports a second deactivated radio from the at least one second radio and if so, activate said deactivated second radio.

6. The method of claim 5, comprising announcing activation of a second radio over at least one already active radio from the at least one first radio and at least one second radio.

7. The method according to claim 5, wherein the determination of the support by a client device of one or more second radios is performed on the basis of an item of information contained in a frame received from the client device.

8. A method according to claim 5, comprising transmitting to the client device a request to transition to an access point of said second radio once activated.

9. A communication device comprising
at least one first radio configured to be active when the device is in operation;
at least one second radio configured to be selectively active or deactivated when the device is in operation;
a processor and a memory having code that when executed by the processor causes the device to:
in response to a disassociation event of a client device associated with an access point of an active radio from the at least one first radio and at least one second radio, determine whether a second active radio is supported by at least one other client device associated with an access point of one of the active radios from the at least one first radio and at least one second radio, and
if not, deactivate said active second radio.

10. The device of claim 9, wherein determining the support of one or more second radios by a given client device is determined on the basis of information contained in an association frame previously received from the given client device.

11. The device according to claim 9, wherein the determination is performed after a time delay (T2) following the disassociation event.

12. The device according to claim 9, wherein the deactivation of a second radio comprises shutting down the power supply of one of:
all active components of the radio;
at least one power amplification circuit.

13. A method implemented by a communication device comprising
at least one first radio configured to be active when the device is in operation;
at least one second radio configured to be selectively active or deactivated when the device is in operation;
a processor and memory containing code that when executed by the processor causes the communication device to perform the method, the method comprising:
in response to a disassociation event of a client device associated with an access point hosted by an active radio from the at least one first radio and at least one second radio, determining whether a second active radio is supported by at least one other client device associated with an access point of one of the active radios from the at least one first radio and at least one second radio, and
if not, deactivating said second active radio.

14. The method of claim 13, wherein determining the support by a given client device of one or more second radios is determined from information contained in an association frame previously received from the given client device.

15. The method according to claim 13, wherein the determination is performed after a time delay (T2) following the disassociation event.

16. The method of claim 13, wherein deactivating a second radio comprises shutting down the power supply to one of:
all active components of the radio;
at least one power amplification circuit.
